(19) United States
(12) Patent Application Publication
(10) Pub. No.: US 2010/0239357 A1
(43) Pub. Date: Sep. 23, 2010

(54) MARKER APPARATUS

(76) Inventor: Terence William Bolton, Redhill (GB)

Correspondence Address: LUMEN PATENT FIRM, 350 Cambridge Avenue, Suite 100, PALO ALTO, CA, 94306, US

(21) Appl. No.: 12/733,222

(22) PCT Filed: Sep. 1, 2008
(86) PCT No.: PCT/GB2008/002961

§ 371 Date: Apr. 26, 2010

(30) Foreign Application Priority Data
Aug. 27, 2007 (GB) 0716842.0

(51) Int. Cl. B05C 21/00

(52) U.S. Cl. 401/196

(57) ABSTRACT

An apparatus for applying a mark to a substrate, the apparatus comprising a housing (10) for containing a reservoir of marker fluid, a marker fluid retaining nib (12) protruding from one end of the housing and drawing marker fluid from the reservoir, the nib having a marking surface (18,20) contoured by one or more recesses (14) or protrusions, whereby, when the marking surface (18,20) is applied to a substrate an uneven distribution of marker fluid is deposited from the nib (12) onto the substrate resulting in a non uniform mark.

This invention relates to a marker apparatus and more especially a marker apparatus in the form of a pen-shaped ink stamp.

Typically ink stamps comprise a hand-held device that has a flat end or stamping surface with a raised pattern formed thereon. The stamping surface is inserted in a pool of ink before being pressed on to suitable substrate to provide a reverse image of the pattern on the substrate. Ink is transferred from the raised pattern directly on to the substrate

Ink stampers are known which comprise an elongate housing with a flattened stamping surface which is connected via a conduit to an ink reservoir in the housing. Ink is supplied to the stamping surface from the reservoir through capillary action. When the stamping surface is pressed against a substrate ink is deposited in a reverse image of the raised pattern and is replenished with ink which is drawn from the reservoir to the stamping surface via the conduit.

Such ink stamps provide a two-dimensional reverse image of the pattern formed on the stamping surface when the patterned stamping surface is pressed against a substrate. Transfer of the pattern to the substrate requires direct contact of the raised pattern with the substrate; no pattern is produced where there is not contact with the substrate.

The patterns produced by a stamp appear two-dimensional, although the pattern or some parts of the pattern may have a textured appearance.

Typical marker pens comprise an elongate housing having a fibrous felt-like nib connected to a marking fluid reservoir via a liquid absorbent wick. The nib has a substantially smooth surface which is applied to a substrate to produce a single uniform line of colour.

One object of the present invention is to provide marking apparatus in the form of a marker pen which serves both to provide a single uniform line of colour and a pattern having a three dimensional appearance when applied to a substrate.

According to a first aspect, there is provided apparatus for applying a mark to a substrate, the apparatus comprising a housing containing a reservoir of marker fluid, a marker fluid retaining nib protruding from one end of the housing and drawing marker fluid from the reservoir, the nib having a marking surface contoured by one or more recesses or protrusions, whereby, when the marking surface is applied to a substrate an uneven distribution of marker fluid is deposited from the nib onto the substrate resulting in a non uniform mark.

It will be appreciated that the marking surface can be used to stamp a reverse image of the contoured surface onto a substrate but if moved across the substrate can provide a uniform line in much the same manner as a conventional marker pen.

Marking fluid drawn from the reservoir accumulates more densely in the boundaries of the recesses or the protrusions and so is deposited more densely onto the substrate when the apparatus is used as a stamp. Varying pressure can be applied to the nib to produce a more varied distribution of the marking fluid and a three dimensional appearance of the stamped image.

A recess may comprise without limitation a shaped indentation, a slot or a through hole in the nib.

Optionally, the marking surface comprises an end surface and a surface inclined to the end surface, and at least one recess or protrusion is formed in the inclined surface.

In another option, the marking surface is generally curved. In one embodiment, the nib is substantially dome shaped.

In one option, the nib is generally frusto-conical in shape and the contoured pattern is provided on the truncated surface of the cone.

Optionally, one or more protruding nib portions may be provided within the boundaries of a recessed nib portion, the protruding portions extending to a position which approximates to the height of the nib which bounds the recess.

Desirably the nib comprises a pressure sensitive material. For example but without limitation, the pressure sensitive material is Porex. The use of a pressure sensitive nib is particularly advantageous in that the the size of the printed image can be affected and controlled by altering the pressure applied to the nib. Smaller pressures will result in smaller prints, larger pressure, prints of larger dimensions. This greatly increases the variety of images which can be produced by an artist employing the apparatus in the creation of artwork.

Preferably, the apparatus takes the form of a pen, wherein the nib is replenished by fluid present in a chamber positioned within the housing.

It will be appreciated that by different orientation of the pen, contoured portions of the marking surface of the nib can be applied to stamp a pattern, while portions which are not contoured can be applied to draw a continuous and uniform line.

The nib may be connected to and configured to draw marking fluid from the reservoir through a wick. The reservoirs may conveniently be provided in the form of a chamber for example in the form of a transorb. A transorb essentially comprises a quantity of fluid retaining material positioned within a fluid impermeable sheath. The fluid retaining material may be a fibrous material. The sheath has an open end which receives a wick by which fluid present in the transorb is transferred by capillary action to the nib.

The marking fluid present in the chamber may comprise (but is not strictly limited to) an indicator such as water-based ink containing coloured dye, dispersed pigment or other colouring medium.

In a particular embodiment, the apparatus comprises an elongate housing from one end of which protrudes a fluid absorbent nib, the nib surface being at least partially convex and including an opening which extends to a position below the convex surface of the nib. The opening is desirably in the form of a recess, but may alternatively comprise a through hole.

Optionally the convex nib surface is inclined with respect to the longitudinal centre line of the housing. In this embodiment, the angle of inclination of that part of the convex nib surface below the opening is larger than the angle of inclination of that part of the convex nib surface above the opening. Desirably, the angle of inclination of the nib surface below the opening is approximately 45 degrees and the angle of inclination of the nib surface above the opening is approximately 30 degrees.

The invention will now be described by way of example only with reference to the accompanying diagrammatic drawings, in which:—

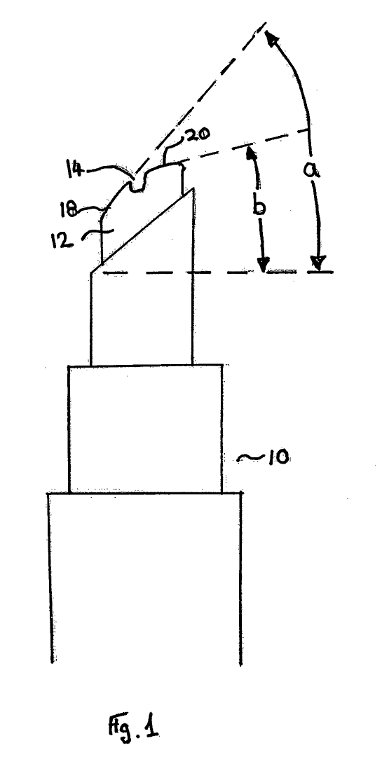

FIG. 1 is a front schematic view of the marking device constructed in accordance with an embodiment of the invention;

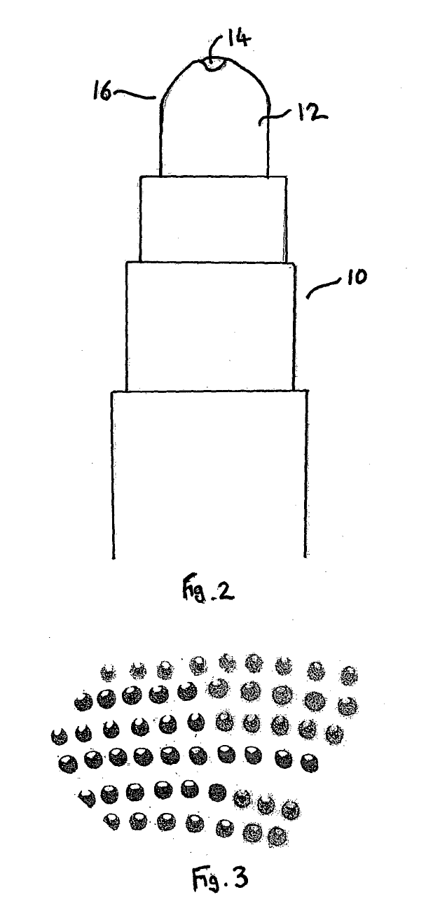

FIG. 2 is side view of a marking device of FIG. 1 showing the nib in cross-section; and

FIG. 3 is an illustration of an example of a pattern that the marking device of FIGS. 1 and 2 could produce during use.

Both FIGS. 1 and 2 are schematic drawings of the invention and are not to scale. The overall structure of the embodiment hereinafter described is that of a marker pen but for the purposes of this application it is only the marking means that is illustrated and described in detail. The internal workings of the pen are constructed of known features in the field of marker pens and are not generally described in detail. It is however clearly envisaged that the marking device need not have a pen-like structure behind the marking means.

Referring to FIG. 1, a marking device comprises a housing 10, which in this embodiment takes the form of a tubular pen-like structure.

At one end of the housing 10 extends a nib 12. The nib 12 is made from a fluid retaining fibrous material common place in marker pens. The nib 12 is generally frusto-conical in shape. The nib 12 has a recess 14 formed in part of its outer surface 16. As can be seen best from FIG. 2, the recess 14 extends partially into the surface of the nib 12. The recess 14 may, however, extend through the entire length of the nib 12.

Referring now to FIG. 2, the nib 12 has a curved surface 18 whose tangent is inclined at an angle “a” of approximately 45° to the normal and a further surface 20 inclined at an angle “b” of approximately 30° to the normal.

The curved surface 18 and the inclined surface 20 form the marking surface which, in use, produces a mark, which can be in the form of a shape or pattern, on a substrate. Drawing of the marking surface across a substrate results in a continuous uniform mark much as provided by a conventional marker pen.

The recess 14 is formed in the marking surface 20 of the nib 12. The recess 14 may, for example, be a circular aperture, as shown in the Figures, or may have an alternatively shaped boundary. More than one recess 14 may be formed in the marking surface 20. Alternatively, protrusions could be formed on the marking surface 20, or alternatively still, a mixture of protrusions and recesses (which may have varying heights/depths). The recesses and/or protrusions formed on the marking surface 20 define the pattern applied to a substrate when the marking surface is pressed against the substrate.

The shape of the nib 12 provides a responsive marking tip during use which has a spring or rubber like feel. The shape also allows the marking device to be used at an angle that is the same or similar to that of a standard pen which makes the apparatus very easy to use, particularly for children.

The nib 12 is replenished by fluid present in a chamber positioned within the pen housing 10. The fluid present in the chamber may comprise an indicator such as water-based ink containing coloured dye, dispersed pigment or other colouring medium.

The nib 12 is connected to receive fluid from the first chamber through a wick. The chamber typically comprises a transorb. A transorb essentially comprises a quantity of fluid retaining fibrous material positioned within an impermeable sheath. The fluid retaining material may be a fibrous material. The sheath is typically open at both ends one of which receives a wick by which fluid present in the transorb is passed by capillary action to the nib 12.

An effect provided by a nib 12 of this construction, is illustrated in FIG. 3. The shape and construction of the nib 12 provides for an apparently three-dimensional pattern or shape to be applied to a substrate with one press of the marking surface against the substrate.

Clearly, FIG. 3 illustrates only an example of shapes and patterns that could be produced. In this case, the shape would be provided by a single circular recess 14 in the marking surface 20 of the nib 12. You will see from FIG. 3 that the marking surface 20 provides a 3-dimensional ball image 22 (a number of images have been illustrated to forming the basis of a pattern). The recess 14 provides an absence of marking which gives the appearance of a reflection on the surface of the each ball 22 to the eye of the user. The shape and construction of the nib 12 also provides for a heavier flow of ink to the centre of each ball shape 22 (as can be seen by a darker portion) which further enhances the appearance of three-dimension to the human eye.

It will be appreciated that the foregoing is merely exemplary of artist tools in accordance with the invention and that various modifications can readily be made thereto without departing from the true scope of the invention described as set out in the appended claims.

1-15. (canceled)

16. A marker apparatus for applying a mark to a substrate, comprising a housing for containing a reservoir of marker fluid and a fluid absorbent nib which protrudes from one end of the housing and is connected to draw fluid from the reservoir, the apparatus being characterised in that the nib has a surface which is at least partially convex and includes at least one opening which is bordered on all sides by the convex surface of the nib and extends to a position below the nib surface.

17. The marker apparatus as claimed in claim 16, characterised in that the at least one opening comprises a recess.

18. The marker apparatus as claimed in claim 16, characterised in that the at least one opening comprises a through-hole.

19. The marker apparatus as claimed in claim 16, characterised in that the convex nib surface is inclined with respect to the longitudinal centre line of the housing.

20. The marker apparatus as claimed in claim 19, characterised in that the angle of inclination of that part of the convex nib surface closest to the housing is larger than the angle of inclination of that part of the convex nib surface furthest to the housing.

21. The marker apparatus as claimed in claim 20, characterised in that the angle of inclination of the nib surface closest to the housing is approximately 45°.

22. The marker apparatus as claimed in claim 20, wherein the angle of inclination of the nib surface furthest from the housing is approximately 30°.

23. The marker apparatus as claimed in claim 16, characterised in that the contour of the or each opening is generally circular.

24. The marker apparatus as claimed in claim 16, characterised in that there is provided within the contour of the or each opening a protruding nib portion which extends to a position which approximates to the height of the nib surface which surrounds the contour of the or each opening.
